(19) United States
(12) Patent Application Publication
(10) Pub. No.: US 2014/0099981 A1
(43) Pub. Date: Apr. 10, 2014

(54) METHOD AND SYSTEM FOR COMMUNICATING BETWEEN A MOBILE DEVICE AND A REMOTE DEVICE

(71) Applicant: Mark Horbal, Chicago, IL (US)

(72) Inventor: Mark Horbal, Chicago, IL (US)

(73) Assignee: SHC DIRECT, L.L.C., Downers Grove, IL (US)

(21) Appl. No.: 13/645,622

(22) Filed: Oct. 5, 2012

(51) Int. Cl. H04B 5/06; H04W 4/14

(52) U.S. Cl. 455/466; 455/41.1

(57) ABSTRACT

A system and method that allows for near field communication between a mobile device and a remote or stationary device that does not include a NFC reader, and in a particular embodiment, for communication between a mobile device and a remote device via a third-party agent or broker in order to provide direct or indirect communication between the mobile and remote devices.

This invention claims benefit to U.S. patent application Ser. No. 13/113,128, filed May 23, 2011, which claims benefit to U.S. Provisional Patent Application Ser. No. 61/408,247, filed Oct. 29, 2010, the entireties of which are hereby incorporated by reference.

### FIELD OF THE INVENTION

The invention relates to systems and methods that allow for wireless communications between devices, and more particularly, near field communication (“NFC”) between devices.

### BACKGROUND OF THE INVENTION

The number of wireless or mobile devices in the United States and the rest of the world continues to grow with most estimates indicating that the number of wireless devices in the United States currently exceeds the country's population. Wireless devices are also becoming more sophisticated and allow the users to perform a wide variety of tasks.

Some wireless devices utilize NFC chips or systems to establish communication with a remote device by touching it or bringing the devices in close proximity to one another. In order to receive information from the wireless device in this manner, the remote device typically incorporates a reader that receives identifying information from the mobile device, which then permits an action to take place (e.g., charge account for purchase or remit reward or loyalty card data). While readers allow information from mobile devices to be received, they are often expensive and require additional software or hardware to integrate them into the remote device. Accordingly, despite NFC capabilities being incorporated into mobile or personal wireless devices, very few remote devices utilize NFC readers.

One application for wireless communication is between a mobile device and point of sale (“POS”) terminals or other devices typically associated with a “cash register” function. Although many scenarios can be envisioned where a communication between a mobile device and an in-store POS terminal would be desirable, very few POS terminals have the ability to engage in such communication.

It is evident that a mobile device and POS terminal each have the ability to communicate. For example: POS terminals can communicate via the Internet or other means to accomplish tasks such as credit card validation, gift card purchase/redemption, inventory checks et al.; nearly all mobile devices can send and receive SMS (“text”) messages; and most smart mobile devices have the ability to communicate with the Internet and perform secure, encrypted communications, such as banking transactions and the like.

POS terminals, on the other hand, are limited as to the ability to communicate with mobile or wireless devices. This is not an inherent limitation. It is generally attributable to factors such as, but not limited to: the POS terminal being a dedicated, special purpose computer or device and its software feature set does not provide for this type of communication; and/or neither the POS terminal nor mobile device knows the identity of the other and hence cannot communicate with it.

Therefore there is a need for a system and method that permits remote devices and mobile devices to easily communicate, directly or indirectly, with one another. There is a further need for a system and method that establishes NFC communication between a mobile device and a remote or stationary device that does not utilize a NFC reader.

### SUMMARY OF THE INVENTION

The present invention is an improvement over the prior art in the way that it facilitates communications between a mobile device and a remote device such as a stationary device (e.g., a POS terminal). The system and method of the invention provides for each of the remote device and mobile device to communicate via a third-party agent in order to affect direct, or indirect, communication between the remote device and the mobile device.

The invention discloses communication between such mobile devices, in the possession of customers or users who are interacting with the remote device. The system and method of the present invention enables one to establish reliable and effective near field communication between a portable mobile device and a remote device without requiring the remote device to have a NFC reader. This is particularly important because of the significant costs connected with implementing NFC modifications, especially for large operations with a multitude of stores or locations, such as many national operations.

In one embodiment, the remote device includes a NFC transmitter (e.g., in the form of a tag or sticker). Instead of transmitting the identity of the mobile device user to a NFC reader associated with the remote device, the mobile device includes a NFC reader that reads the unique tag ID or other information stored on the NFC tag and is configured to know the tag ID. The mobile device then transmits the tag ID and user identification information stored in or associated with the mobile device to a third party broker system in a known way such as, but not limited to, through web services or wireless telecommunications transmissions. The operator of the remote device also transmits the tag ID to the third party broker system through, among other things, a hard-line, web-based or a wireless telecommunications connection.

Upon the timely receipt of the communications from the mobile device and the remote device, the third party broker system analyzes or reviews the transmitted information to determine if the tag ID or other information matches. If the information matches, the broker system may notify the parties and provide the user identification information to the remote device to permit further operations to commence.

It is therefore an object of the present invention to create a system and method for permitting communication between a mobile device and a remote device that is cost effective and easy to operate.

It is another object of the present invention to create a system and method that permits communications between a wireless device and a remote device that does not have a NFC reader.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a schematic diagram showing one embodiment of the present invention that provides indirect, brokered communication between a mobile device and a remote or stationary device such as a POS terminal.

FIG. 2 is a flow chart diagram depicting one embodiment of the steps involved in providing indirect, brokered communication between a mobile device and a remote or stationary device.

FIG. 3 is a schematic diagram illustrating direct communication between a mobile device and a remote or stationary device such as a POS terminal.

FIG. 4 is a flow chart diagram depicting one embodiment of the steps involved in providing direct, brokered communication between a mobile device and a remote or stationary device.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention.

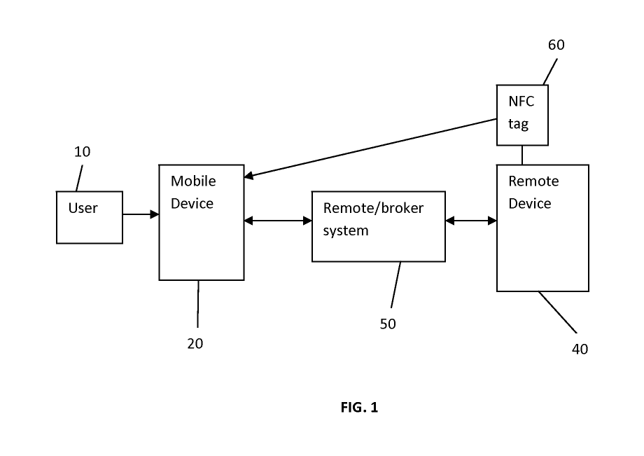

Referring to FIG. 1, the system and method of the present invention generally involve a customer or individual 10 using a mobile device 20 that communicates with a remote or stationary device (e.g., a POS terminal) 40 having a NFC transmitter or tag 60 through the assistance of a broker 50. Although the example set forth herein involves a POS terminal, it is appreciated that the remote or stationary device may be any form of device in which a user may establish communications with including, but not limited to, other devices typically associated with a “cash register” function, parking meters, vending machines and transportation terminals. Particularly, it is appreciated that the invention is directed to communications between two otherwise non-communicating devices via a third party broker.

In one embodiment, the mobile device 20 may be a handheld, wireless device such as, but not limited to, a telephone, portable tablet or micro notebook computer, however, it is appreciated that the mobile device may be any form of mobile device that may be used by a consumer to receive and transmit information according to the present invention. Depending upon the transaction or service that is desired to be performed, it is appreciated that the mobile device may contain software applications that facilitate the desired process or function. For example, in the case of payment services and/or coupon management and redemption, the mobile device may contain a software application that functions at least in part as a “wallet” that may contain one or more coupons/offers and that has been configured with the customer's identifying information.

For purposes of this disclosure, it is appreciated that the broker 50 refers to a remote system that, among other things, permits the receipt and transmission of communications with the mobile device and remote device, and which may have a memory to store data and information regarding the transaction and any related information (e.g., coupons or offers). While the term broker is shown in the drawings and described in one embodiment herein, the term is used for exemplary purposes wherein it is appreciated that the remote system may be any of the known computer systems that allows or facilitates communication between the mobile device and remote device and not depart from the scope of the present invention. One embodiment of a broker or broker system is a web service system with two methods, one accessed by the POS terminal or other remote device and one accessed by the mobile device. In operation, the broker or broker system is set to receive messages from both the remote device and the mobile device using, for example, conventional SOAP protocol and XML-formatted content or other web services and associated protocols such as, but not limited to, REST, JSON or WCF. Typically, the messages must be received within a certain set time period relative to one another in order to allow the transaction to proceed without resending the message(s). Thus, the first message received is held for the maximum set time period waiting to see if the counterpart message is received. It is appreciated that the messages may be received in any order and not depart from the scope of the invention.

Referring to the example regarding the use of POS terminals, although POS terminals are typically specialized computers or computing devices located in a store or other retail location, it is appreciated that the present invention is not limited to this embodiment. Rather, the invention is applicable to any POS terminals that can communicate with a remote broker. Such POS terminals may include or be equipped with peripherals such as, but not limited to, communication devices, card terminals, laser scanners and printers. The POS terminals typically include software that assists with the customer check-out processes, such as scanning the products, computing totals and taxes, and accepting cash and credit card payments.

It is further appreciated that the mobile device and remote device may communicate with the broker system and each other in a variety of ways. For example, the mobile device, among other things, can communicate over the mobile carrier's data services such as EVDO, 3GS, 4GS, LTE or Wi-Fi, while the POS terminal may, among other things, communicate via its established communication connection.

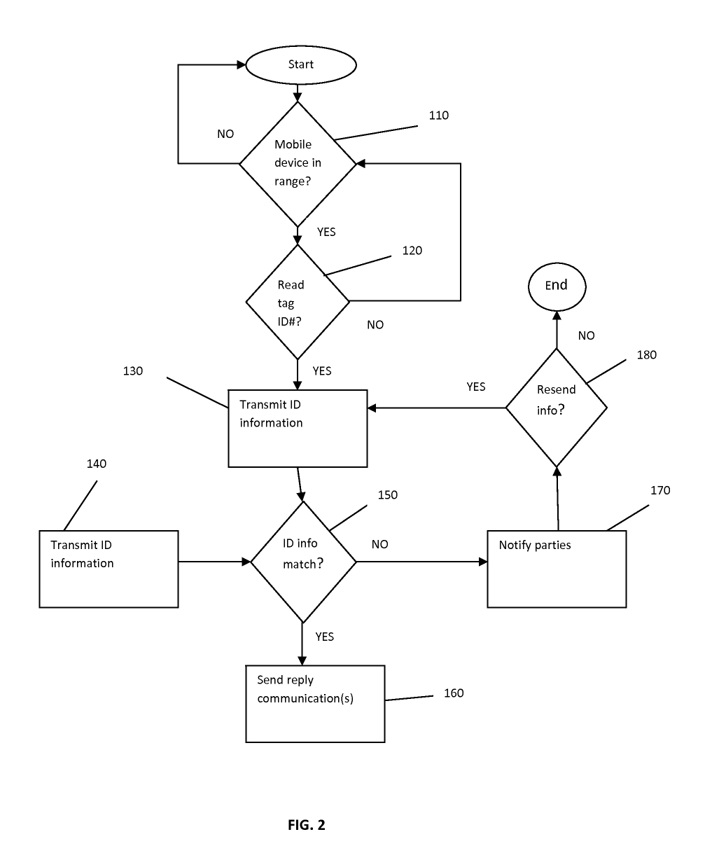

Referring again to FIG. 1, the NFC tag 60 preferably includes identifying information concerning the remote device. While the NFC transmitter is described as a sticker or tag in one embodiment, it is appreciated that it may take any shape or form, or be incorporated into other elements (e.g., as or part of labels, tags or displays) and not depart from the scope of the present invention. FIG. 2 illustrates one embodiment of the steps involved in the communication system and method of the present invention. In operation, a mobile device 20 having a NFC reader is brought into proximity of the NFC tag or transmitter 60 of the remote device 40 in step 110 to allow the reader to read a unique tag number or tag ID and/or other identifying information regarding the remote device 40 from the NFC tag 60 in step 120. The mobile device is configured to know the tag ID.

The mobile device then transmits the remote device identifying information along with identifying information regarding the mobile device user to the third party broker or remote system in step 130 using a known communication means including, but not limited to, web services or wireless telecommunications connections such as, but not limited to, EVDO, 3GS, 4GS, LTE or Wi-FI. The remote device also transmits the remote device identifying information to the third party broker or remote system in step 140. It is further appreciated that the remote device may also transmit information on the mobile device user to the remote system. The information may be received in any number of ways including, but not limited to, orally from the user or through the scanning of a membership or other card.

After receiving the communications in steps 130 and 140, the broker 50 compares the inbound communication from the mobile device user and the inbound message or communication from the remote device 40 to determine if the information therein matches in step 150. Typically, the messages must be received within a certain set time period relative to one another. Thus, the first message received is held for the maximum set time period waiting to see if the counterpart message is received in order to proceed.

If the broker system determines that the information transmitted with the communications matches in step 150, the broker system will confirm the match via reply communications in step 160. The response to the remote device includes the user identifying information, which will allow for further operation between the remote device and mobile device. If the information does not match, the broker system may notify the mobile device and remote device in step 170 of the failure, thereby permitting the parties, if desired to resend the information or end the process in step 180.

In one embodiment, the broker system also confirms the user identification by matching the user identifying information sent by the mobile device 20 (e.g., through an app) and the same or a corresponding user identifying information that is sent by the POS terminal or other remote device 40 (for example, through the scanning of a consumer's membership card).

The system and method of the present invention thus allow a mobile device to communicate with a remote device without a NFC reader to transmit information between the devices and/or to facilitate services or transactions. In the example of the remote device being a POS terminal, examples of the information or services that may be performed with the present system and method include, but are not limited to: capturing the mobile device user's loyalty, reward or membership information; collecting electronic payment using an account number stored in the mobile device; facilitating payment between the mobile device and a third party; or informing the user regarding available rewards, coupons, offers, etc. based on the user's identity stored in the mobile device.

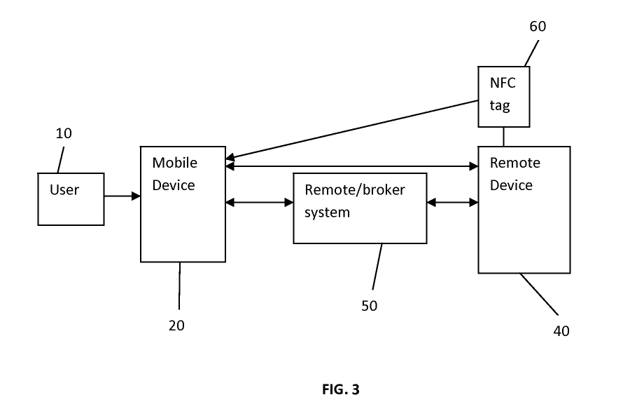

In another embodiment of the present invention, an embodiment of which is shown schematically in FIG. 3, the NFC system and method may also permit the mobile device 20 and remote device 40 to communicate with the broker 50 for the purpose of establishing subsequent direct communications with each other. The communication is facilitated by the Communications Broker (“broker”) 50 and becomes direct once respective identities of the remote device 40 and mobile device 20 are established by the broker 50 and provided to at least one of the parties.

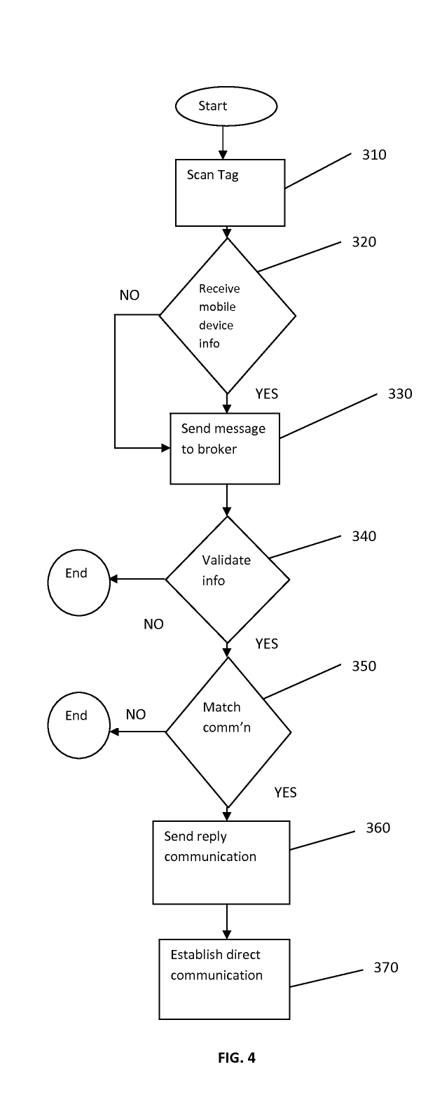

Referring to FIG. 4, the mobile device 20 may scan the NFC tag 60 associated with the POS terminal or other remote device 40 in step 310. An application in the customer's mobile device 20, in step 330, sends a message to the broker 50 with the remote device identifying information as well as the mobile device's network address, for example, its IP address. Additional authentication information also can be exchanged.

If desired, in the case of a POS terminal or other remote device that can receive information from the consumer, the remote device 40 of individual operating or using the remote device may receive identifying information from the mobile device user 10 (e.g., membership or customer ID number) in step 320. The remote device can then communicate that information to the broker 50 to provide information to be compared to verify the user 10.

After receiving messages and validating the identifying information in step 340, the broker 50 matches the inbound communication from the customer 10 and the inbound request from the remote device 40 in step 350 and confirms the match via reply communication to the remote device 40 in step 360. The response communication from the broker 50 to the remote device 40 includes the communication address of the mobile device 20. The broker 50 may also send a response to the mobile device 20. Upon receiving this information from the broker 50, the remote device 40 initiates direct communication with the mobile device 20 in step 370, possibly sending it its own communication address.

Alternately, the broker's 50 response to the mobile device 20 can include the remote device's 40 communication address in step 360. Upon receiving this information from the broker 50, the mobile device 20 initiates direct communication with the remote device 40 in step 370, possibly sending it its own communication address. At this point, communications can occur directly between the mobile device 20 and the POS terminal or other remote device 40.

It will be understood that modifications and variations may be effected without departing from the scope of the novel concepts of the present invention, but it is understood that this application is limited only by the scope of the appended claims.

1. A method for permitting near field communication between a mobile device and a remote device having a NFC transmitter, the method comprising the steps of:
providing a remote system that can communicate with the mobile device and the remote device;
storing customer identification information on the remote system;
receiving a message from the mobile device at the remote system that identifies the customer and remote device information;
receiving a communication from the remote device including the remote device identification information;
comparing the mobile device message with the remote device communication; and
communicating with at least one of the mobile device and remote device if the information transmitted with the mobile device message matches the information transmitted with the remote device communication.

2. The method of claim 1 wherein the customer identification information includes the customer's telephone number.

3. The method of claim 1 wherein the additional information includes notification of the information transmitted with the mobile device matches the information transmitted with the remote device communication.

4. The method of claim 1 wherein the customer identification information includes a loyalty, reward or membership number.

5. The method of claim 1 wherein the mobile device message is a SMS text.

6. The method of claim 1 wherein the mobile device is a smart device.

7. The method of claim 5 wherein the mobile device message is sent from a mobile device application.

8. A method for using a remote system to communicate between a mobile device and a remote device, the remote system communicates separately with the mobile device and the remote device, the method comprising the steps of:
providing a NFC transmitter for use with the remote device, the NFC transmitter including identification information regarding the remote device;
sending a communication from the remote device to a remote system including the remote device identification information; and
receiving a communication from the remote system if the remote device identification information matches information received by the wireless device from the NFC transmitter, the communication including identification information on the mobile device user.

9. The method of claim 7 wherein the customer identification information includes a telephone number.

10. The method of claim 7 wherein the customer identification information includes a loyalty, reward or membership number.

11. A method for permitting direct communicating between a customer's mobile device and a remote device, the method comprising the steps of:
providing a remote system that can communicate with the mobile device and the remote device;
receiving a message from the mobile device at the remote system that identifies the customer and the remote device;
receiving a communication from the remote device at the remote systems including the remote device identification information;
confirming whether the information transmitted with the mobile device message matches the information transmitted with the remote device communication; and
upon confirmation of a match of the transmitted information, providing information to allow for communication between the mobile device and the remote device.

12. The method of claim 11 where the step of providing information to allow for communication between the mobile device and the remote device includes a communication address of the mobile device.

13. The method of claim 11 where the step of providing information to allow for communication between the mobile device and the remote device includes a communication address of the remote device.

14. A communication system for permitting direct communicating between a mobile device and a remote device, the communication system comprising:
the mobile device, wherein the mobile device includes a NFC reader and a transmitter;
the remote device;
a NFC transmitter associated with or in close proximity to the remote device, the NFC transmitter including identifying information for the remote device;
a NFC transmitter, the NFC transmitter including identifying information on the remote device; and
a broker system comprising:
a receiving module for receiving communications from the mobile device and remote device; and
a transmitter for transmitting communication to the mobile device and/or remote device.

15. The communication system of claim 13 wherein the mobile device further comprises a communication module for communicating with the remote device.

16. The communication system of claim 13 wherein the remote device further comprises a communication module for communicating with the mobile device.

17. The communication system of claim 13 wherein the NFC transmitter is a NFC tag.

18. The communication system of claim 16 wherein the NFC tag is a sticker.
